(19) United States
(12) Patent Application Publication
(10) Pub. No.: US 2012/0048700 A1
(43) Pub. Date: Mar. 1, 2012

(54) COMPUTER KEYS WITH INWARDLY TAPERED BOTTOM

(75) Inventor: YUNG-LUNG LIU, Ta Ya Shiang (TW)

(73) Assignee: Sunrex Technology Corp., Ta Ya Shiang (TW)

(21) Appl. No.: 12/873,339

(22) Filed: Sep. 1, 2010

(51) Int. Cl. H01H 13/70; H01H 13/705

(52) U.S. Cl. 200/5 A; 200/344

(57) ABSTRACT

A computer keyboard includes a base plate; a film circuit board; a spacer plate; a rubber plate; a key housing; a plurality of pivotal scissor shaped structures; and a plurality of keys each comprising a key cap and a periphery depending downward from the key cap to inwardly taper toward bottom. The keyboard has the following advantages: Increased key cap surface for printing or engraving additional characters or Braille characters on the key cap. Debris or other foreign objects are not easy to enter the keyboard through gaps between keys. The keyboard can be made low-profile.

### BACKGROUND OF THE INVENTION

1. Field of Invention

The invention relates to computer keyboards and more particularly to computer keys each having an inwardly tapered bottom with improved characteristics.

2. Description of Related Art

Laptops are widely used throughout the world. Laptops are advantageous for being lightweight, portable, low profile, and having features very close to that of desk top computers.

Typically, a laptop is equipped with a scissor-switch keyboard. In detail, a plurality of scissor switches each is mounted between a key and a base plate. Scissor-switch keyboards are advantageous for being lightweight, low-profile, and easy operation. However, its assembly is a time consuming and tedious job due to its layered structure. This inevitably decreases production and greatly increases the manufacturing cost.

There is a typical type of computer keyboard having keys with vertical periphery. Moreover, there is another typical type of computer keyboard having keys with flare periphery. Both designs have the drawback of reduced top surface (i.e., effective area for printing or engraving characters). Further, small areas mean that it is difficult of printing or engraving additional characters or Braille characters on the keys. Furthermore, debris or other foreign objects may enter the keyboard through gaps between keys. All of these are not desirable. Thus, the need for improvement still exists.

### SUMMARY OF THE INVENTION

It is therefore one object of the invention to provide a computer keyboard comprising a base plate; a film circuit board; a spacer plate; a rubber plate; a key housing; a plurality of pivotal scissor shaped structures; and a plurality of keys each comprising a key cap and a periphery depending downward from the key cap to inwardly taper toward bottom.

The above and other objects, features and advantages of the invention will become apparent from the following detailed description taken with the accompanying drawings.

### BRIEF DESCRIPTION OF THE DRAWINGS

FIG. 1 is an exploded view of a computer keyboard according to the invention;

FIG. 2 is a fragmentary view of FIG. 1 showing a single key and associated components therebelow to be assembled;

FIG. 3 is a perspective view of the key;

FIG. 4 is a fragmentary view of the top of the assembled keyboard;

FIG. 5 is a longitudinal sectional view of two assembled keys and its components in FIG. 2;

FIG. 6 is a view similar to FIG. 5 with one key being pressed; and

FIG. 7 is a top plan view of the assembled keyboard.

### DETAILED DESCRIPTION OF THE INVENTION

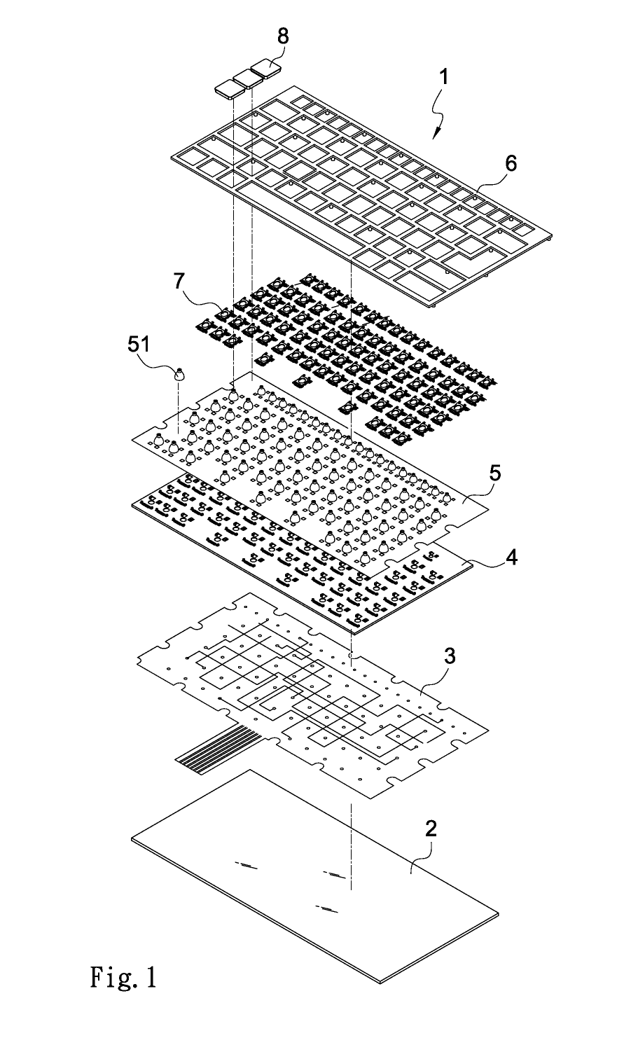

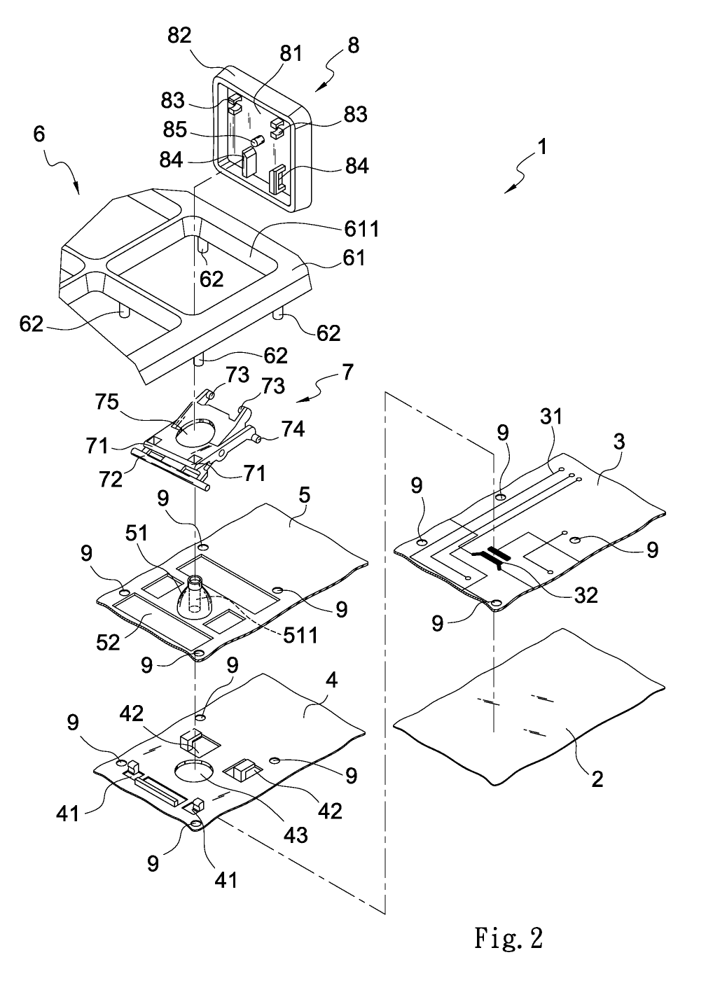

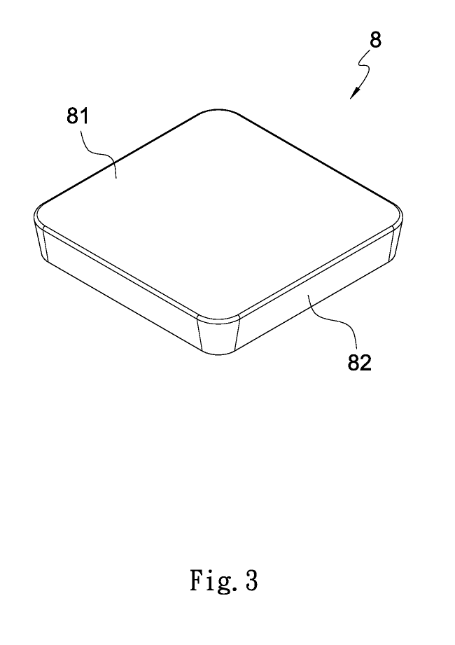

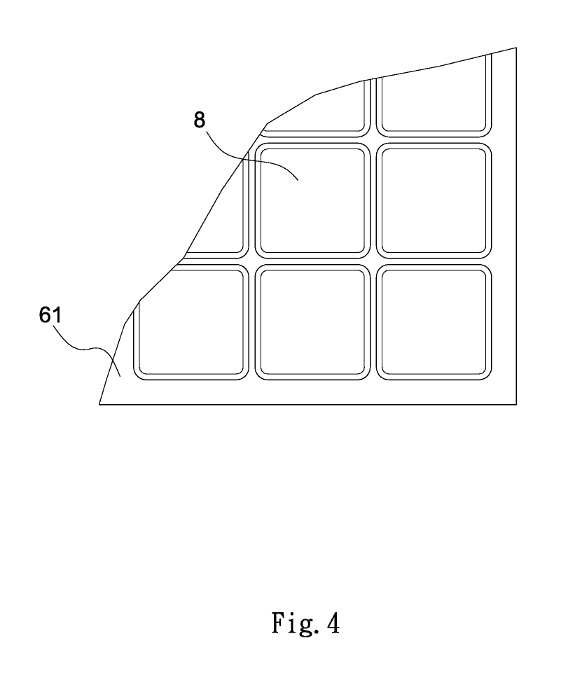

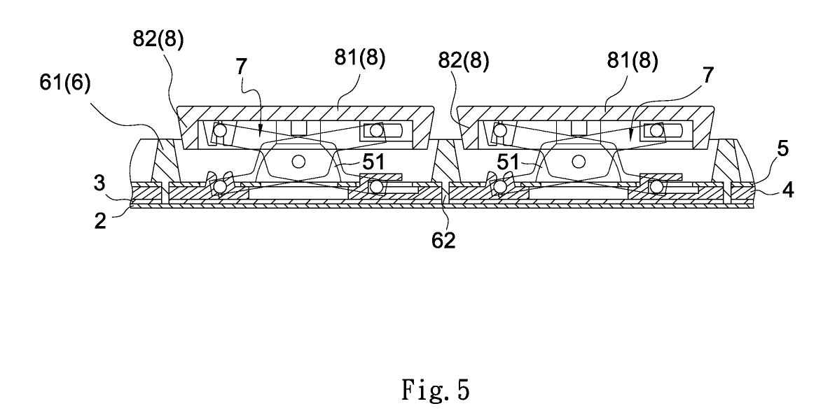

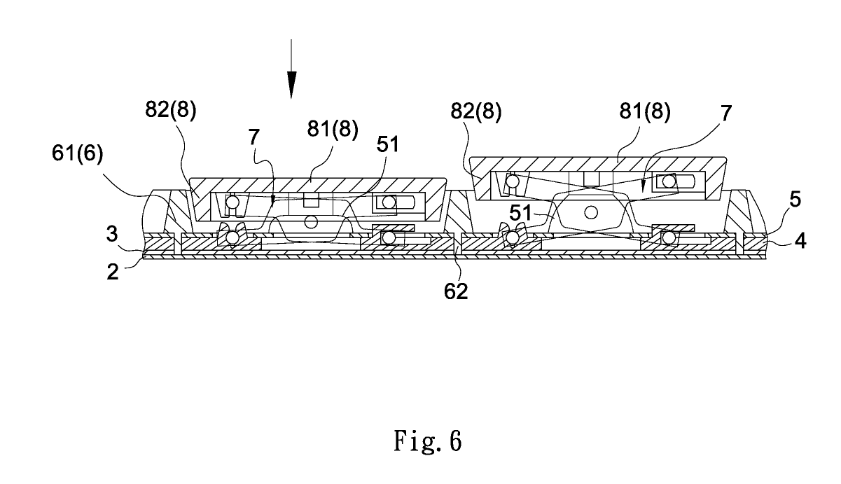

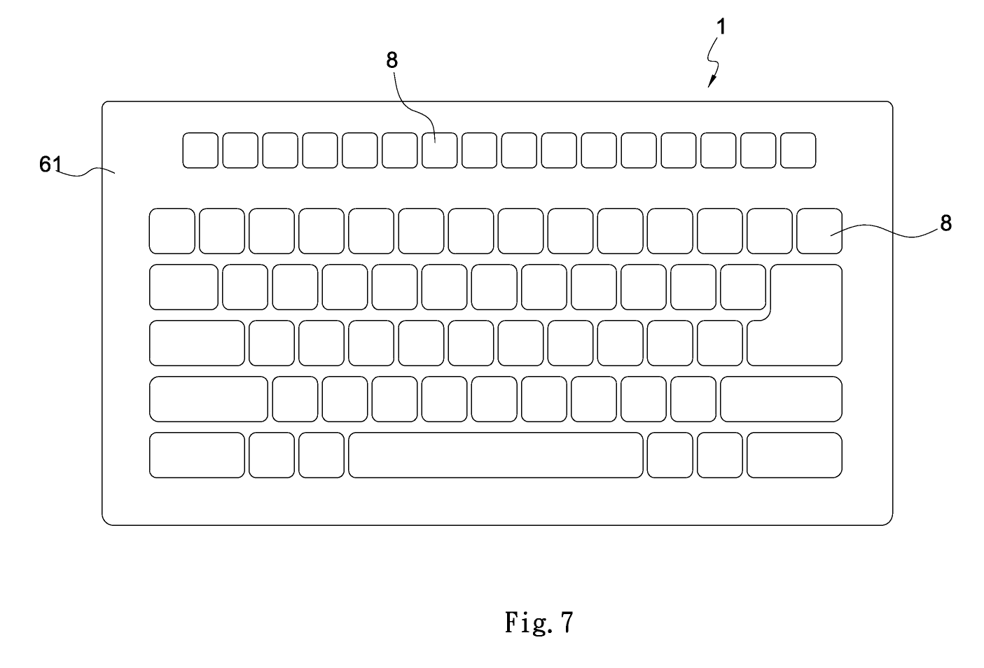

Referring to FIGS. 1 to 7, a computer keys in accordance with the invention comprises the following components as discussed in detail below.

A base plate 2 is waterproof. A film circuit board 3 is provided on the base plate 2 and comprises a circuitry 31 electrically connected to a power source (not shown), and a plurality of switch contacts 32.

A spacer plate 4 is made of aluminum or plastic and is provided on the film circuit board 3. The spacer plate 4 comprises a plurality of units each including two snapping grooves 41 as one group, two slide guide grooves 42 as the other group, and two holes 43 formed between the groups. The hole 43 is disposed on the switch contact 32. The number of the holes 43 corresponds to that of the switch contacts 32.

A rubber plate 5 is provided on the spacer plate 4 and comprises a plurality of resilient domes 51 aligned with the hole 43 therebelow, the dome 51 having a top receptacle (not numbered) and a conductive stem 511 on bottom, and a plurality of holes 52 each with the snapping grooves 41 or the slide guide grooves 42 passing through.

A rectangular key housing 6 is provided on the rubber plate 5 and comprises a plurality of rectangular frame members 61 integrally formed together, each frame member 61 having four curved corners and a periphery 611 inwardly tapered toward bottom, and a plurality of legs 62 inserted through apertures 9 on the rubber plate 5, apertures 9 on the spacer plate 4, and apertures 9 on the film circuit board 3 to urge against the base plate 2 for fastening the key housing 6, the rubber plate 5, the spacer plate 4, and the film circuit board 3 together.

A plurality of scissor shaped structures 7 are disposed on the rubber plate 5. The scissor shaped structure 7 comprises two first slide axles 73 at two corners of a first frame (not number), two second slide axles 74 at two corners of a second frame (not number) pivotal about the first frame, the second slide axles 74 being below the first slide axles 73, a first pivot shaft 71 at the opposite side of the second frame, a second pivot shaft 72 at the other side of the first frame parallel to and below the first pivot shaft 71, and a central circular hole 75. The second slide axles 74 are slidably secured to the slide guide grooves 42 and the second pivot shaft 72 is rotatably secured to the snapping grooves 41 respectively.

A plurality of keys 8 each has a cross-section of rectangle in this embodiment but not limited to. The key 8 has four curved corners and comprises a key cap 81, a periphery 82 depending downward from the key cap 81 to inwardly taper toward bottom, two pivot grooves 83 on bottom of the key cap 81, two slide guide grooves 84 also on the bottom of the key cap 81 with the pivot grooves 83 together arranged as four corners of a virtual quadrilateral, and a shaft 85 extending downward from center of the bottom of the key cap 81.

Each key 8 is fitted in the hollow of the frame member 61 with the periphery 82 being spaced from the periphery 611 by a small predetermined distance and the shaft 85 passing the circular hole 75 to dispose in the receptacle of the dome 51. Also, the first pivot shaft 71 is rotatably secured to the pivot grooves 83 and the first slide axles 73 are slidably secured to the slide guide grooves 84 respectively.

In use, a user may press the key 8 to push down the shaft 85 which in turn presses the dome 51 with the scissor shaped structure 7 being elastically compressed. Thus, the stem 511 contacts the switch contact 32 to close a circuit (i.e., switch). As a result, the depressed key 8 is activated. Further, signals in response the key pressing are generated as well known in a key pressing operation.

The invention has the following advantages: Increased key cap surface for printing or engraving additional characters or Braille characters on the key cap. Further, debris or other foreign objects are not easy to enter the keyboard through gaps between keys. The keyboard can be made low-profile.

While the invention has been described in terms of preferred embodiments, those skilled in the art will recognize that the invention can be practiced with modifications within the spirit and scope of the appended claims.

What is claimed is:

1. A computer keyboard, comprising a base plate, a film circuit board, a spacer plate, a rubber plate, a key housing, a plurality of pivotal scissor shaped structures, and a plurality of keys, wherein each key comprises a key cap and a periphery depending downward from the key cap to inwardly taper toward bottom.

2. The computer keyboard of claim 1, wherein the key housing comprises a plurality of rectangular frame members integrally formed together, each frame member having a periphery inwardly tapered toward bottom, and wherein each key is disposed in the frame member with the periphery thereof being spaced from the periphery of the frame member by a predetermined distance.

3. The computer keyboard of claim 1, wherein the film circuit board is disposed on the base plate, the spacer plate is disposed on the film circuit board, the rubber plate is disposed on the spacer plate, the key housing is disposed on the rubber plate, and the scissor shaped structures are disposed between the rubber plate and the key housing.

4. The computer keyboard of claim 1, wherein the key cap has a rectangular cross-section.

5. The computer keyboard of claim 1, wherein the key further comprises two pivot grooves on the bottom of the key cap, two slide guide grooves on the bottom of the key cap opposite the pivot grooves, and a shaft extending downward from the bottom of the key cap to retain in the dome; wherein the scissor shaped structure comprises two upper first slide axles at two corners, two lower second slide axles at another two corners the same side as the first slide axles, an upper first pivot shaft opposing the first slide axles, a lower second pivot shaft opposing the second slide axles and at the same side as the first pivot shaft, and a central hole; wherein the first pivot shaft is rotatably secured to the pivot grooves and the first slide axles are slidably secured to the slide guide grooves respectively; wherein the second slide axles are slidably secured to the second groove connectors and the second pivot shaft is rotatably secured to the first groove connectors respectively; wherein the stem passes the central hole; and wherein the shaft is aligned with and disposed above the stem by a predetermined distance.
